(19) United States
(12) Patent Application Publication
(10) Pub. No.: US 2026/0271823 A1
(43) Pub. Date: Sep. 17, 2026

(54) DISPENSER FOR SEEDLINGS

(71) Applicant: NOVELQUIP FORESTRY (PTY) LTD, George (ZA)

(72) Inventors: Helgaard Petrus Steenkamp, George (ZA); Daniel Jacobus Bauermeister, Mosselbay (ZA); Greig Oppenheimer, Knysna (ZA)

(73) Assignee: NOVELQUIP FORESTRY (PTY) LTD, George (ZA)

(21) Appl. No.: 19/469,928

(22) PCT Filed: Mar. 26, 2024
(86) PCT No.: PCT/ZA2024/050010

§ 371 Date: Sep. 26, 2025

(30) Foreign Application Priority Data
Apr. 3, 2023 (ZA) 2023/04074

(51) Int. Cl. A01C 11/02

(52) U.S. Cl. CPC A01C 11/02

(57) ABSTRACT

A dispenser for dispensing seedlings includes: (i) a housing; (ii) a first hub; (iii) a first string of tubes for containing items to be dispensed, which first string of tubes are: open at a first axial end; hingedly connected to each other; and wound about the first hub; (iv) a first guide disposed within the housing and spaced from the first hub, against which first guide the first string of tubes make contact as the first string of tubes unwinds from the first hub; and (v) a first chute associated with the first guide into which first chute items contained within the first string of tubes are dispensed via the first axial end of the first string of tubes, as the first string of tubes pass the first guide.

### BACKGROUND

The present invention relates to a dispenser. More specifically, the present invention relates to a dispenser for dispensing seedlings to be planted.

Various seedling dispensers are known. For example:
EP3011817 “Device and method for transplanting plants” describes: a carrier divided into tubular cells with open axial ends; a seedling stored within each cell; an indexing device that controls removal of seedlings from their cells; a funnel operatively beneath the carrier for receiving seedlings that fall from their cells; and a chute that extends operatively downwards from the funnel. A drawback of this dispenser is that the cells are not aligned with the chute, increasing the risk of seedlings becoming stuck in the funnel.
WO2015097348 “Planting machine and method for planting seedlings” and U.S. Pat. No. 6,615,753 “Expandable stinger planter” describe a circular tray that is divided into tubular cells with open axial ends; a seedling stored within each cell; a circular plate that defines an aperture; a motor for rotating the tray on the plate and a chute extending operatively downwards from the aperture defined by the plate, wherein alignment of a cell with the aperture defined by the plate causes the seedling to fall under the influence of gravity from the cell into the chute. A drawback of this dispenser is that, as the tray is rotated, the operative bottom of each seedling is abraded (by shear wear) against the operative upper surface of the plate.
US2021/0015028 “Sapling retrieval apparatus for planting saplings” describes a tray of seedlings and an arm that: picks the seedlings out of the tray; and deposits them in a chute. A drawback of this dispenser is that seedlings become entangled with neighbouring seedlings and removal of a single seedling from the tray is not always possible.

It is an object of this invention to address these drawbacks.

### SUMMARY OF THE INVENTION

According to a preferred embodiment of the invention, there is provided a dispenser that includes:
a housing;
a first hub;
a first string of tubes for containing items to be dispensed, which first string of tubes are:
   open at a first axial end;
   hingedly connected to each other; and
   wound about the first hub;
a first guide disposed within the housing and spaced from the first hub, against which first guide the first string of tubes make contact as the first string of tubes unwinds from the first hub to the second hub; and
a first chute associated with the first guide into which first chute items contained within the first string of tubes are dispensed via the first axial end of the first string of tubes, as the first string of tubes pass the first guide.

Preferably, the Dispenser Further Includes:
a second hub about which the first string of tubes unwound from the first hub may be wound; and
a first connector for securing a first terminal end of the first string of tubes to the second hub.

Typically, the first hub extends from a first circular disk that is secured against relative rotation to a first axial end of the first hub, which first hub and first circular disk forms a first spool that is removable from the housing.

Generally:
when the first string of tubes is wound about the first hub, the first axial end of the first string of tubes is supported on the circular disk; and
the second axial end of the first string of tubes is open.

Preferably, housing defines a first base, and wherein:
a portion of the first base extending from the first circular disk to the first chute; and
the first circular disk,
   form a planar surface.

Typically, the first base of the housing defines a ridge that extends operatively upwards about at least a peripheral portion of the first circular disk.

Generally, the First Guide Is Rotatably Connected to the Housing

Preferably, the first chute inlet defines a funnel for facilitating receipt of items within the first chute.

Typically:
a first flexible pad is secured to the housing and spaced from the radial periphery of the first guide so as to create a gap therebetween that is less than the outer diameter of the tubes, so as to create a friction fit between:
   the tubes; and
   the first guide and first flexible pad,
   as the first string of tubes pass the first guide; and
   the first chute inlet is disposed between and operatively below the first flexible pad and the first guide.

Generally, the axis of the first chute is spaced from the first guide a distance equal to the distance the axis of a tube forming part of the first string of tubes is spaced from the first guide when such tube is in contact with the first guide and dispenses the item contained within such tube.

Preferably, the dispending device further includes a platform on which the housing is securable, wherein the platform includes:
a winder for rotating the second hub; and
an encoder that is associated with the first guide for:
   sensing rotation of the first guide; and
   controlling: rotation of the second hub, or rotation of the first guide.

Typically, the dispensing device further includes a locking mechanism that prevents rotation of the first and second hubs in one direction when the housing is secured to the platform.

Generally, the dispensing device further includes rollers on the operative underside of the first circular disk for facilitating rotation and linear movement of the first circular disk on the housing.

Preferably:
the housing defines a second base operatively spaced above the first hub, the first guide and the second hub, and
the dispensing device further includes:
   a second spool comprising: a third hub; and second circular disk secured to a first axial end of the third hub, which second spool is receivable within the housing operatively above the second base;
   a second string of tubes for containing items to be dispensed, which second string of tubes are:
      open at a first axial end;
      hingedly connected to each other; and
      wound about the third hub;
   a fourth hub about which the second string of tubes unwound from the third hub may be wound;
   a second connector for securing a first terminal end of the second string of tubes to the fourth hub;
   a second guide disposed between the third and fourth hubs, against which second guide the second string of tubes make contact as the second string of tubes unwinds from the third hub to the fourth hub; and
   a second chute associated with the second guide into which second chute items contained within the second string of tubes are dispensed via the first axial end of the second string of tubes, as the second string of tubes pass the second guide.

Typically:
the fourth hub extends axially from a second axial end of the second hub; and
the winder causes: rotation of the second hub in a first direction, and rotation of the fourth hub in a second direction.

Generally:
a common shaft extends axially through the second and fourth hubs,
a first ratchet connects the second hub to the common shaft to lock the second hub and common shaft against relative rotation in a first direction; and
a second ratchet connects the fourth hub to the common shaft to lock the fourth hub and the common shaft against relative rotation in a second direction that is opposite to the first direction of relative rotation.

Preferably, the first and second chutes converge towards a common third chute.

Typically:
the first chute defines an air inlet and an air outlet, wherein the first chute air inlet is spaced further from the third chute than the air outlet defined by the first chute;
the second chute defines an air inlet and an air outlet, wherein the second chute air inlet is spaced further from the third chute than the air outlet defined by the second chute; and
the dispensing device further includes a blower for, in use, directing air into: the first chute air inlet and the second chute air inlet.

Generally, the dispending device further includes:
a first door for preventing removal of the first spool from the housing; and
a second door for preventing removal of the second spool from the housing.

Preferably:
a first mount is secured to the housing, for releasably securing the second axial end of the first hub to the first mount while permitting relative rotation of the first hub and the first mount; and
a second mount is secured to the housing, for releasably securing the second axial end of the third hub to the second mount while permitting relative rotation of the third hub and the second mount.

Typically, the third chute extends to a planting device with a pair of jaws that regulates release of items conveyed by the third chute.

### BRIEF DESCRIPTION OF THE DRAWINGS

The invention will now be described in more detail, by way of example only, with reference to the accompanying drawing in which:

FIG. 1 is a perspective view of a dispenser according to a preferred embodiment of the invention;

FIG. 2 is an exploded upper perspective view of the dispenser according to FIG. 1;

FIG. 3 is an exploded lower perspective view of the dispenser according to FIG. 1;

FIG. 4 is a perspective view of a portion of a string of tubes forming part of the dispenser according to FIG. 1;

FIG. 5 is a cross-sectional view through A-A in FIG. 7;

FIG. 6 is a perspective view of the dispenser in FIG. 1 secured to a planting vehicle; and

FIG. 7 is a cross-sectional plan view through B-B in FIG. 1.

### DESCRIPTION OF THE INVENTION

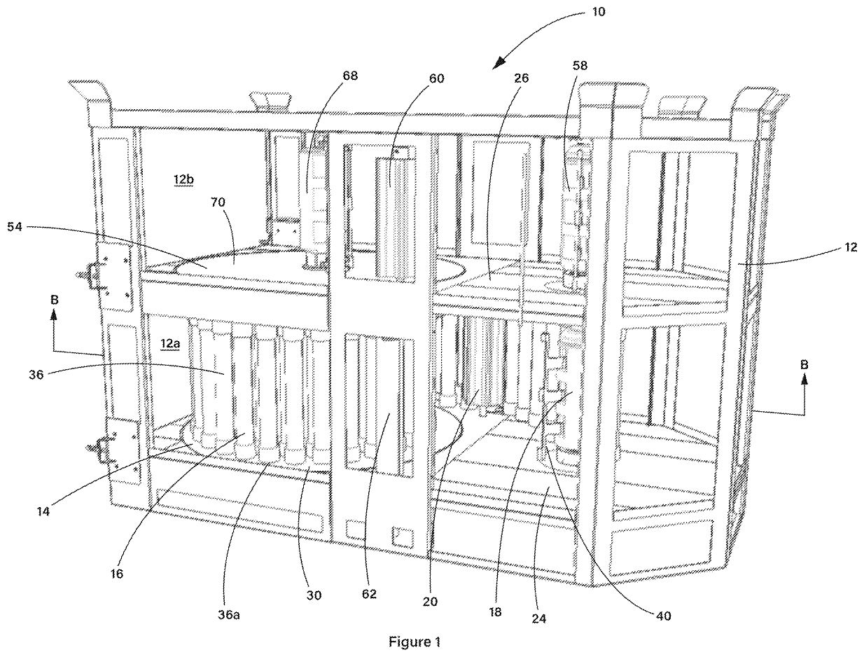

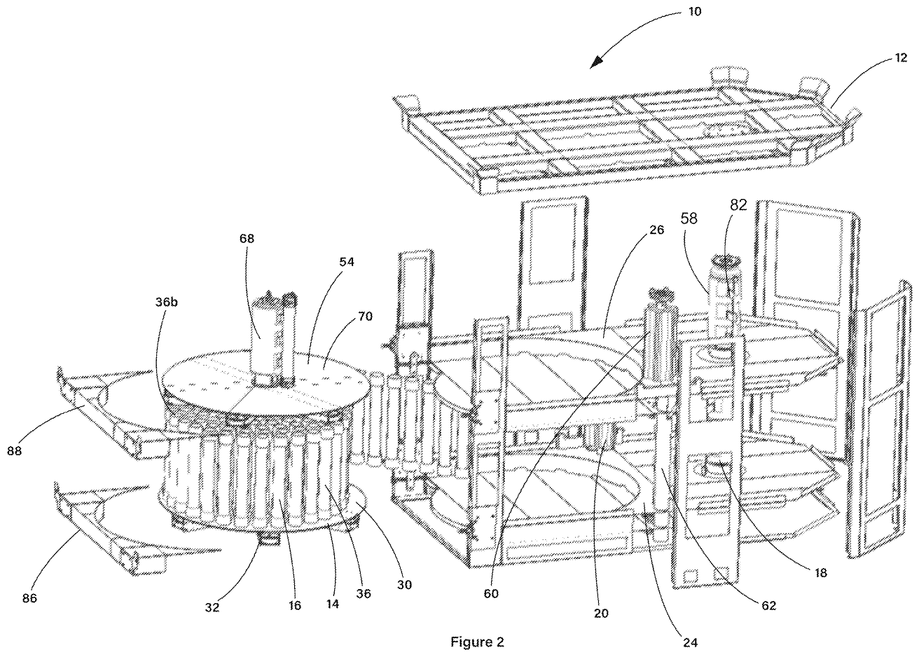

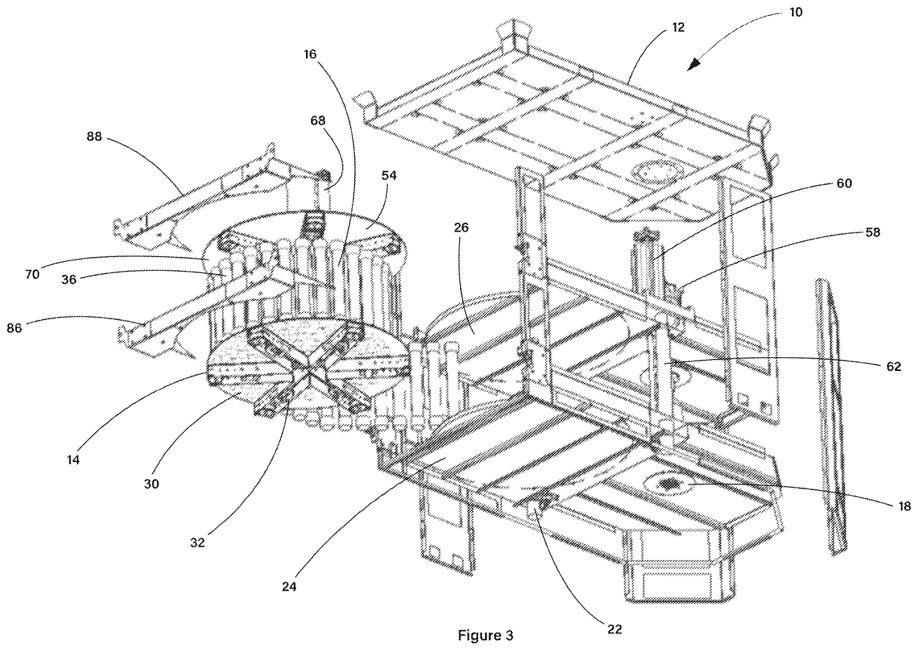

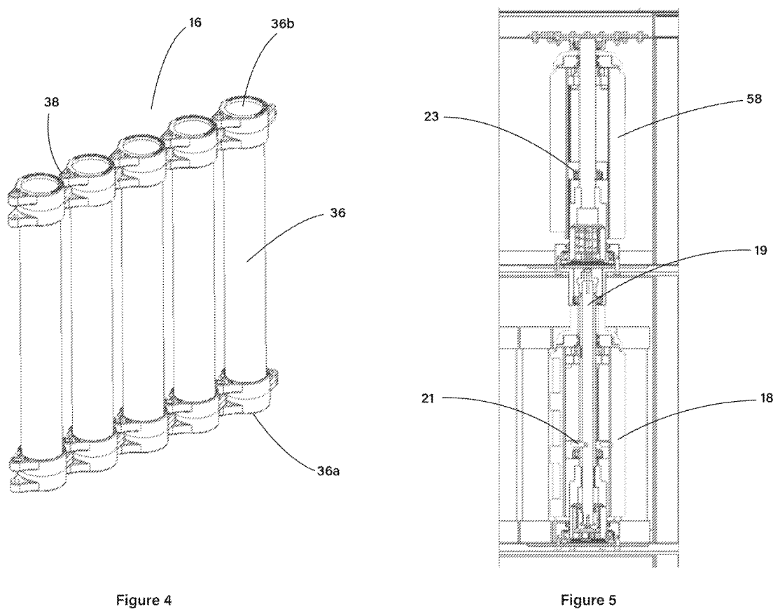

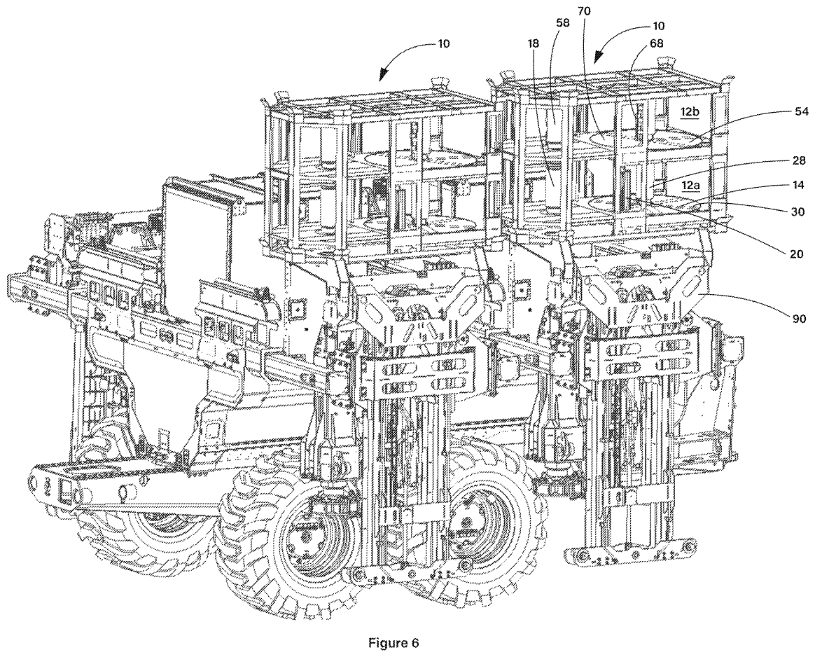

With reference to FIGS. 1 to 7, a dispenser 10 according to a preferred embodiment of the invention includes: a housing 12; a first spool 14; a first string of tubes 16; a second hub 18; a first guide 20; and a first chute 22. The dispenser 10 is used to store and dispense items, such as seedlings (for planting).

The housing 12 defines: a first base 24 and a second base 26, that divides the chamber defined by the housing into: an operative lower chamber 12a defined between the first and second bases 24 and 26; and an operative upper chamber 12b defined above the second base 26.

The first spool 14 comprises a first hub 28; and a first circular disk 30, wherein a first axial end of the first hub 28 is secured against relative rotation to the first circular disk 30, extending axially from the centre of the first circular disk 30. The first spool 14 is insertable into/removable from the operative lower chamber 12a defined by the housing 12. When the first spool 14 is inserted into the operative lower chamber 12a defined by the housing 12, the first spool 14 is supported on the first base 24 of the housing 12. The first circular disk 30 includes rollers 32 on the operative underside of the first circular disk 30 for facilitating rotation and linear movement of the first circular disk 30 on the first base 24 of the housing 12 (and, when the first spool 14 is on the ground).

The first base 24 of the housing 12 defines a ridge (not shown) that extends operatively upwards about at least a peripheral portion of the first circular disk 30 when the first spool 14 is received within the operative lower chamber 12a defined by the housing 12.

The first string of tubes 16 comprise a set of right circular cylindrical tubes 36 that are open at an operative lower first axial end 36a and an operative upper second axial end 36b and that are hingedly connected to each other via a tube connector 38 near each axial end 36a and 36b of the tubes 36. Although, the tube connector 38 has been shown as a hinged connection, it will be appreciated that the tube connector 38 could alternatively be a flexible connector (such as a strap). Each tube 36 is sized to receive an item, such as a seedling (not shown) therein. It will also be appreciated that, although the tubes 36 are shown as being right circular cylindrical, the tubes 36 may be any other shape in axial cross-section, e.g. square, octagonal, etc.

The first string of tubes 16 is wound about the first hub 28 of the first spool 14, with the first axial 36a end of the string of tubes 16 (i.e. the operative lower end of each tube 36 that forms part of the string of tubes 16) supported on the operative upper surface of the first circular disk 30. A flexible sheet 39 extends from a first terminal end 16a of the first string of tubes 16.

The second hub 18 is generally right circular cylindrical and is rotatably secured to the first base 24 of the housing 12, extending substantially perpendicular from the first base 24 of the housing 12. The second hub 18 is radially spaced from the first hub 28 and from the first circular disk 30.

A first connector 40 secures a free end of the sheet 39 to the second hub 18, thereby securing the first terminal end 16a of the first string of tubes 16 to the second hub 18.

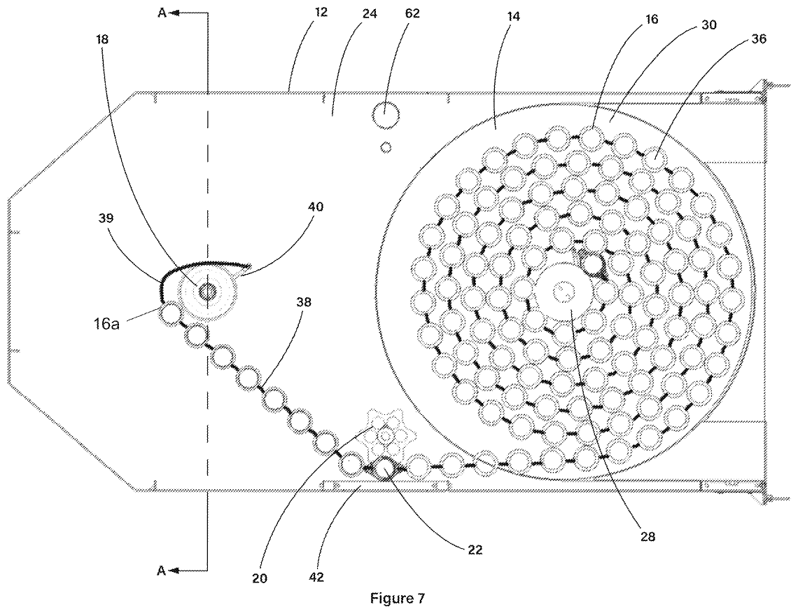

Turning to FIG. 7, the first guide 20 is disposed within the housing 12 and is also rotatably connected to the first base 24 of the housing 12, extending substantially perpendicular from the first base 24 of the housing 12. In axial cross-section, the first guide 20 is in the shape of a sprocket, for receiving tubes 36 between sprocket teeth. The first guide 20 is disposed between the first and second hubs 28 and 18. It will be appreciated that the term “between” is not intended to require the first guide 20 to be disposed along a virtual line connecting the axes of the first and second hubs 28 and 18. Instead, “between” is intended to mean that the first guide 20 is spaced from both the first and second hubs (e.g. to form a triangle (preferably, an acute triangle, i.e. where none of the internal angles are obtuse) between the axis of the first and second hubs 28 and 18 and the axis of the first guide 20). More specifically, the first guide 20 is:
radially spaced from: the first hub 28; the first circular disk 30; and the second hub 18; and
spaced from a virtual plane that extends between the axes of rotation of the first and second hubs 28 and 18.

The first string of tubes 16 extends from the first hub 28, past the first guide 20 and to the second hub 18. The first string of tubes 16 makes contact with the first guide 20, with the tubes 36 releasably received between the sprocket teeth defined by the first guide 20, as the first string of tubes 16 unwinds from the first hub 28 to the second hub 18.

The first chute 22 defines an inlet at the first base 24 of the housing 12 and extends operatively downwards from the first base 24 of the housing 12. More specifically, the first chute 22 inlet is arranged such that, when the first string of tubes 16 passes the first guide 20, the first axial end 36a of the first string of tubes 16 passes over the first chute 22 inlet, dispensing items from the first string of tubes 16 into the first chute 22. The first chute 22 defines a funnel (not shown) at its inlet to facilitate receipt of items dispensed from the first string of tubes 16 into the first chute 22.

As is apparent from FIG. 1:
a portion of the first base 24 of the housing 12 that extends from the first circular disk 30 to the first chute 22; and
the first circular disk 30,
   form a planar surface to facilitate smooth sliding travel of the first axial end 36a of the first string of tubes 16 from its wound configuration about the first hub 28 towards the first chute 22.

It will be appreciated that, since the first circular disk 30 rotates with the first hub 28, there is no relative sliding movement between the first axial end 36a of the first string of tubes 16 and the first circular disk 30 as the first string of tubes 16 unwind from the first hub 28, until such time as a tube 36 that forms part of the first string of tubes 16 begins its linear sliding travel towards the first chute 22. It will be appreciated that, by limiting relative movement between the first axial end 36a of the first string of tubes 16 and the first circular disk 30 during unwinding of the first string of tubes 16, shear wear of items contained within the first string of tubes 16 is reduced during the dispensing process.

Turning to FIG. 7, a first flexible pad 42 is secured to the housing 12, spaced from the radial periphery of the first guide 20 so as to create a gap therebetween that is less than the outer diameter of the tubes 36 that form part of the first string of tubes 16 (when the tubes are received between the sprocket teeth defined by the first guide 20). This arrangement creates a slight friction fit between the tubes 36 and the first flexible pad 42 as the tubes 36 pass the first guide 20. Optionally, this arrangement could also induce a slight friction fit between the tubes 36 and the first guide 20 during travel of the tubes 36 past the first guide 20. Friction between the tubes 36 and the first flexible pad 42 assists in controlling the position of the tubes 36 as they pass the first guide 20.

The first chute 22 inlet is disposed between and operatively below the first flexible pad 42 and the first guide 20 (i.e. within the gap defined between the first flexible pad 42 and the first guide 20). More specifically, the axis of the first chute 22 is spaced from the first guide 20 a distance equal to the distance the axis of a tube 36 forming part of the first string of tubes 16 is spaced from the first guide 20 when the tube 36 is in contact with the first guide and dispenses the item contained within the tube 36.

The first spool 14, second hub 18, first guide 20 and first string of tubes 16 is repeated in the operative upper chamber 12b defined by the housing 12. More specifically, the operative upper chamber 12b defined by the housing 12 includes:
a second spool 54 comprising: a third hub 68; and a second circular disk 70 secured to a first axial end of the third hub 68;
a second string of tubes (not shown, but similar to the first string of tubes 16) for containing items to be dispensed, which second string of tubes:
   includes: a series of tubes that are open at a first axial end and are hingedly connected to each other via a tube connector; and
   are wound about the third hub 68 with the first axial end of the tubes supported on the operative upper surface of the second circular disk 70.
a fourth hub 58 that is rotatably connected to the second base 26 of the housing 12 and about which the second string of tubes unwound from the third hub 68 may be wound;
a second connector 82 for securing a first terminal end of the second string of tubes to the fourth hub 58;
a second guide 60 disposed between the third and fourth hubs 68 and 58, against which second guide 60 the second string of tubes makes contact as the second string of tubes unwinds from the third hub 68 to the fourth hub 58; and
a second chute 62 associated with the second guide 60 into which second chute 62 items contained within the second string of tubes are dispensed via the first axial end of the second string of tubes, as the second string of tubes pass the second guide 60.

Turning to FIG. 5, the fourth hub 58 extends axially from a second axial end (i.e. the operative upper axial end) of the second hub 18. A common shaft 19 extends axially through the second and fourth hubs 18 and 58 and:
a first ratchet 21 connects the second hub 18 to the common shaft 19 to lock the second hub 18 and common shaft 19 against relative rotation in a first direction; and
a second ratchet 23 connects the fourth hub 58 to the common shaft 19 to lock the fourth hub 58 and the common shaft 19 against relative rotation in a second direction that is opposite to the first direction of relative rotation.

It will be appreciated that rotation of the common shaft 19 in a first direction will cause rotation of the second hub 18 without rotating the fourth hub 58 within the housing 12, whereas rotation of the common shaft in a second direction will cause rotation of the fourth hub 58 without rotating the second hub 18 within the housing 12.

The first and second chutes 22 and 62 converge towards a common third chute (not shown) that extends operatively downwards. Each of the first and second chutes 22 and 62 defines an air inlet and an air outlet, wherein the air inlet is spaced further from the third chute than the air outlet defined by the first and second chutes 22 and 62. The purpose of the air inlets and outlets is to facilitate travel of items along the first and second chutes 22 and 62 in the region between the air inlets and outlets and towards the third chute, and thereby prevent blockage within these regions.

A blower (not shown) directs air into the air inlets defined by the first and second chutes 22 and 62.

A first door 86 is hingedly connected to the first base 24 of the housing 12 to retain/facilitate removal of the first spool 14 within/from the operative lower chamber 12a defined by the housing 12, and a second door 88 is hingedly connected to the second base 26 of the housing 12 to retain/facilitate removal of the second spool 54 within/from the operative upper chamber 12b defined by the housing 12.

First and second mounts (not shown) are also secured to the housing 12 operatively above the second axial ends of the first and third hubs 28 and 68, respectively. The first and second mounts releasably receive the second axial end of the first and third hubs 28 and 68 therein, respectively, thereby rotatably to support the second axial end of the first and third hubs 28 and 68.

The housing 12 is releasably securable to a platform 90 (which may be supported on a vehicle chassis), which platform 90 includes:
a winder (not shown) for rotating the common shaft 19 and, thereby, the second and fourth hubs 18 and 58; and
an encoder (not shown) that is associated with the first and second guides 20 and 60 for: sensing rotation of the first and second guides 20 and 60; and controlling rotation of the second and fourth hubs 18 and 58 and/or rotation of the first and second guides 20 and 60.

Although, the winder has been described as rotating the second and fourth hubs 18 and 58 via the common shaft 19, it will be appreciated that a winder may alternatively rotate the first and second guides 20 and 60 to move the strings of tubes 16 over the chutes 22 and 62. In such alternative arrangement, the second and fourth hubs 18 and 58 may simply be biased to induce rotation.

Preferably, the blower is also supported on the platform 90, thereby to ensure that expensive and sensitive motors and sensors are secured to the platform 90 and not on or in the housing 12. This reduces the cost of the housing 12 and its contents. It also addresses duplication of motors and sensors where a plurality of housings 12 (with contents) are associated within a single platform.

Furthermore, the dispenser 10 may include a locking mechanism (not shown) that prevents rotation of the first, second, third and fourth hubs 18, 28, 58 and 68 in one direction when the housing 12 is secured to the platform 90. By preventing rotation of the first, second, third and fourth hubs 18, 28, 58 and 68 in one direction when the housing 12 is secured to the platform 90, the first and second strings of tubes 16 can only be unwound from the second and fourth hubs 18 and 58 back onto the first and third hubs 28 and 68 when the housing 12 is removed from the platform 90.

When used as a dispenser for a seedling planter, the third chute extends to a planting device that includes a pair of jaws that regulates release of items (i.e. seedlings) conveyed by the third chute from the dispenser 10 to the planting device.

In use:
The first and second spools 14 and 54 are placed on the ground with the first and second strings of tubes 16 wound about the first and third hubs 28 and 68.
Items (e.g. seedlings) are inserted into the tubes 36 via their open second axial end 36b.
The items travel under the influence of gravity along the tubes 36 until they abut the operative upper surface of the first and second circular disks 30 and 70.
The first and second spools 14 and 54 (with items contained within the tubes 36) are then inserted into the operative lower chamber 12a and the operative upper chamber 12b of the housing 12, respectively.
The first terminal ends of the first and second strings of tubes 16 are unwound from the first and second spools 14 and 54 and secured to the second and fourth hubs 18 and 58, respectively, via the first and second guides 20 and 60, thereby ensuring that the first and second strings of tubes 16 make contact with the first and second guides 20 and 60, respectively.
The housing 12 (with its contents) is then secured to the platform 90.
The platform is driven (via a vehicle (not shown), e.g. a tractor, a tracked vehicle, etc.) to a predetermined position and the: second hub 18; and/or the first guide 20, is/are rotated by the winder to align a tube 36 forming part of the first string of tubes 16 with the first chute 22.
When the tube 36 is aligned with the first chute 22, the item contained within the tube 36 is permitted to fall under the influence of gravity from the tube 36, along the first chute 22, along the third chute and to the planting device.
The planting device forces the jaws into the ground before opening the jaws to release the seedling in the ground.
The platform 90 is then driven to the next predetermined position where the operation is repeated.
When all the items have been dispensed from the first string of tubes 16, the operation is repeated in respect of the second string of tubes, i.e.:
   The: fourth hub 58; and/or the second guide 60, is/are rotated by the winder to align a tube forming part of the second string of tubes with the second chute 62.
   When the tube is aligned with the second chute 62, the item contained within the tube is permitted to fall under the influence of gravity from the tube, along the second chute 62, and along the third chute to the planting device.
   The planting device forces the jaws into the ground before opening the jaws to release the seedling in the ground.
   The platform is then driven to the next predetermined position where the operation is repeated.
   When all the items have been dispensed from the second string of tubes:
      the housing 12 is removed from the platform 90;
      the first and second spools 14 and 54 are rotated to wind the first and second strings of tubes 16 from the second and fourth hubs 18 and 58 back onto the first and third hubs 28 and 68;
      the first and second doors are swung open to permit removal of the first and second spools 14 and 54 from within housing 12; and
      the first and second spools 14 and 54 are removed from the housing 12 to permit the first and second strings of tubes 16 to be recharged with seedlings.

By controlling movement of the tubes 36 above the first and second chutes 22 and 62, the risk of items causing a jam during the dispensing process is reduced. Furthermore, by reducing the distance the first axial ends 36a of the tubes 36 travel over the first and second circular disks 30 and 70 and the first and second bases 24 and 26, respectively, shear wear on items contained within the tubes 36 is reduced. Where the items are seedings, such reduced shear wear assists in maintaining the quality of seedlings planted, as damage to the seedlings' sensitive roots is reduced. Even further, by providing two tiers of spools 14 an 54 with strings of tubes 16, the capacity of the dispenser 10 is increased without increasing its horizontal footprint.

1. A dispenser (10) including:
a housing (12);
a first hub (28);
a first string of tubes (16) for containing items to be dispensed, which first string of tubes (16) are:
open at a first axial end;
hingedly connected to each other; and
wound about the first hub (28);
a first guide (20) disposed within the housing (12) and spaced from the first hub (28), against which first guide (20) the first string of tubes (16) make contact as the first string of tubes (16) unwinds from the first hub (28); and
a first chute (22) associated with the first guide (20) into which first chute (22) items contained within the first string of tubes (16) are dispensed via the first axial end of the first string of tubes (16), as the first string of tubes (16) pass the first guide (20),
characterised in that the dispenser further includes:
a second hub (18) about which the first string of tubes (16) unwound from the first hub (28) may be wound; and
a first connector (40) for securing a first terminal end of the first string of tubes (16) to the second hub (18).

2. The dispenser (10) according to claim 1, wherein the first hub (28) extends from a first circular disk (30) that is secured against relative rotation to a first axial end of the first hub (28), which first hub (28) and first circular disk (30) forms a first spool (14) that is removable from the housing (12).

3. The dispenser (10) according to claim 2, wherein:
when the first string of tubes (16) is wound about the first hub (28), the first axial end of the first string of tubes (16) is supported on the circular disk (30); and
the second axial end of the first string of tubes (16) is open.

4. The dispenser (10) according to claim 3, wherein the housing (12) defines a first base (24), and wherein:
a portion of the first base (24) extending from the first circular disk (30) to the first chute (22); and
the first circular disk (30),
form a planar surface.

5. The dispenser (10) according to claim 4, wherein the first base (24) of the housing (12) defines a ridge that extends operatively upwards about at least a peripheral portion of the first circular disk (30).

6. The dispenser according (10) to claim 5, wherein the first guide (20) is rotatably connected to the housing (12).

7. The dispenser (10) according to claim 6, wherein the first chute (22) inlet defines a funnel for facilitating receipt of items within the first chute (22).

8. The dispenser according to claim 7, wherein:
a first flexible pad (42) is secured to the housing (12) and spaced from the radial periphery of the first guide (20) so as to create a gap therebetween that is less than the outer diameter of the tubes (36), so as to create a friction fit between:
the tubes (36); and
the first guide (20) and first flexible pad (42),
as the first string of tubes (16) pass the first guide (20); and
the first chute (22) inlet is disposed between and operatively below the first flexible pad (42) and the first guide (20).

9. The dispenser (10) according to claim 8, wherein the axis of the first chute (22) is spaced from the first guide (20) a distance equal to the distance the axis of a tube (36) forming part of the first string of tubes (16) is spaced from the first guide (20) when such tube (36) is in contact with the first guide (20) and dispenses the item contained within such tube (36).

10. The dispenser (10) according to claim 9, further including a platform (90) on which the housing (12) is securable, wherein the platform (90) includes:
a winder for rotating the second hub (18); and
an encoder that is associated with the first guide (20) for:
sensing rotation of the first guide (20); and
controlling: rotation of the second hub (18), or rotation of the first guide (20).

11. The dispenser (10) according to claim 10, further including a locking mechanism that prevents rotation of the first and second hubs (28, 18) in one direction when the housing (12) is secured to the platform (90).

12. The dispenser (10) according to claim 11, further including rollers (32) on the operative underside of the first circular disk (30) for facilitating rotation and linear movement of the first circular disk (30) on the housing (12).

13. The dispenser (10) according to claim 12, wherein:
the housing (12) defines a second base (26) operatively spaced above the first hub (28), the first guide (20) and the second hub (18), and
the dispenser (10) further includes:
a second spool (54) comprising: a third hub (68); and second circular disk (70) secured to a first axial end of the third hub (68), which second spool (54) is receivable within the housing (12) operatively above the second base (26);
a second string of tubes for containing items to be dispensed, which second string of tubes are:
open at a first axial end;
hingedly connected to each other; and
wound about the third hub (68);
a fourth hub (58) about which the second string of tubes unwound from the third hub (68) may be wound;
a second connector (82) for securing a first axial end of the second string of tubes to the fourth hub (58);
a second guide (60) disposed between the third and fourth hubs (68, 58), against which second guide (60) the second string of tubes make contact as the second string of tubes unwinds from the third hub (68) to the fourth hub (58); and
a second chute (62) associated with the second guide (60) into which second chute (62) items contained within the second string of tubes are dispensed via the first axial end of the second string of tubes, as the second string of tubes pass the second guide (60).

14. The dispenser (10) according to claim 13, wherein:
the fourth hub (58) extends axially from a second axial end of the second hub (18); and
the winder causes: rotation of the second hub (18) in a first direction, and rotation of the fourth hub (58) in a second direction.

15. The dispenser (10) according to claim 14, wherein:
a common shaft (19) extends axially through the second and fourth hubs (18, 58),
a first ratchet (21) connects the second hub (18) to the common shaft (19) to lock the second hub (18) and common shaft (19) against relative rotation in a first direction; and
a second ratchet (23) connects the fourth hub (58) to the common shaft (19) to lock the fourth hub (58) and the common shaft (19) against relative rotation in a second direction that is opposite to the first direction of relative rotation.

16. The dispenser (10) according to claim 15, wherein the first and second chutes (22, 62) converge towards a common third chute.

17. The dispenser (10) according to claim 16, wherein:
the first chute (22) defines an air inlet and an air outlet, wherein the first chute (22) air inlet is spaced further from the third chute than the air outlet defined by the first chute (22);
the second chute (62) defines an air inlet and an air outlet, wherein the second chute (62) air inlet is spaced further from the third chute than the air outlet defined by the second chute (62); and
the dispenser (10) further includes a blower for, in use, directing air into: the first chute (22) air inlet and the second chute (62) air inlet.

18. The dispenser (10) according to claim 17, further including:
a first door (86) for preventing removal of the first spool (14) from the housing (12); and
a second door (88) for preventing removal of the second spool (54) from the housing (12).

19. The dispenser (10) according to claim 18, wherein:
a first mount is secured to the housing (12), for releasably securing the second axial end of the first hub (28) to the first mount while permitting relative rotation of the first hub (28) and the first mount; and
a second mount is secured to the housing (12), for releasably securing the second axial end of the third hub (68) to the second mount while permitting relative rotation of the third hub (68) and the second mount.

20. The dispenser (10) according to claim 19, wherein the third chute extends to a planting device with a pair of jaws that regulates release of items conveyed by the third chute.
